(19) United States
(12) Patent Application Publication
(10) Pub. No.: US 2024/0190743 A1
(43) Pub. Date: Jun. 13, 2024

(54) METHOD FOR TREATING ALKALINE FLUORINE-CONTAINING WASTEWATER BY COMBINING INDUCED CRYSTALLIZATION METHOD WITH TUBULAR MEMBRANE FILTER

(71) Applicants: Shenzhen Academy of Environmental Sciences, Shenzhen (CN); Hainan University, Haikou (CN)

(72) Inventors: Gong Cheng, Shenzhen (CN); Sai Wang, Haikou (CN); Xiaodan Chen, Shenzhen (CN); Wei Li, Shenzhen (CN); Tuantuan Wang, Haikou (CN); Rui Lin, Shenzhen (CN); Yiwen Luo, Shenzhen (CN); Yi Chen, Shenzhen (CN)

(21) Appl. No.: 18/424,751

(22) Filed: Jan. 27, 2024

Related U.S. Application Data
(63) Continuation of application No. PCT/CN2023/088267, filed on Apr. 14, 2023.

(30) Foreign Application Priority Data
Jun. 2, 2022 (CN) 2022106198010

(51) Int. Cl. C02F 9/00; C02F 1/00; C02F 1/44; C02F 1/52; C02F 1/56; C02F 1/66

(52) U.S. Cl. CPC C02F 9/00; C02F 2001/007; C02F 1/44; C02F 2001/5218; C02F 1/5245; C02F 1/56; C02F 1/66

(57) ABSTRACT

A method for treating alkaline fluorine-containing wastewater by combining an induced crystallization method with a tubular membrane filter (TMF) includes: introducing fluorine-containing wastewater into a regulating pond to regulate to 8.0-8.5; introducing alkaline fluorine-containing wastewater into a first-stage chemical sedimentation tank, and adding calcium chloride, poly aluminum chloride, calcium fluoride, and tremolite; performing shearing treatment, then introducing into a first-stage coagulation sedimentation tank and a first-stage inclined-tube sedimentation tank in sequence to discharge a first-stage effluent; introducing the first-stage effluent into a second-stage chemical sedimentation tank, adding calcium chloride and poly aluminum chloride, stirring to react, then introducing into a second-stage coagulation sedimentation tank, adding polyacrylamide, and then flowing into a second-stage inclined-tube sedimentation tank, and discharging a second-stage effluent; and performing a treatment by using the TMF, and then discharging a treated second-stage effluent.

### TECHNICAL FIELD

The disclosure relates to the field of wastewater treatment, particularly to a method for treating alkaline fluorine-containing wastewater by combining an induced crystallization method with a tubular membrane filter (TMF).

### BACKGROUND

With the rapid development of industry, a large amount of alkaline fluorine-containing wastewater is generated in the industries such as mining and processing of fluorine-containing ores, production of fluorine and fluoride, etc., and thereby causing great harm to environment and humans. Due to a fact that more than a certain concentration of fluorine has many adverse effects on humans, animal, and plants in nature, it is of significance to optimize a treatment process of the fluorine-containing wastewater, especially for a treatment of high-concentration fluorine-containing wastewater.

### SUMMARY

In view of the above, the disclosure provides a method for treating alkaline fluorine-containing wastewater by combining an induced crystallization method with a tubular membrane filter (TMF) to solve the above-mentioned problems.

Technical solutions of the disclosure are achieved as follows:

A method for treating alkaline fluorine-containing wastewater by combining an induced crystallization method with a TMF includes:
step 1, introducing fluorine-containing wastewater (with a concentration of fluorine ions being a range of 20-30 milligrams per liter abbreviated as mg/L) into a regulating pond, and regulating a potential of hydrogen (pH) of the fluorine-containing wastewater to a range of 8.0-8.5 to obtain the alkaline fluorine-containing wastewater;
step 2, introducing the alkaline fluorine-containing wastewater from the regulating pond into a first-stage chemical sedimentation tank, adding calcium chloride, poly aluminum chloride, calcium fluoride, and tremolite (also referred to as Amphibole var. tremolite) into the first-stage chemical sedimentation tank sequentially in that order to obtain first-stage fluorine-containing wastewater, performing shearing treatment on the first-stage fluorine-containing wastewater by using a high-speed shearing machine to obtain sheared first-stage fluorine-containing wastewater, introducing the sheared first-stage fluorine-containing wastewater into a first-stage coagulation sedimentation tank to obtain first-stage coagulating-sedimentation wastewater, and then introducing the first-stage coagulating-sedimentation wastewater into a first-stage inclined-tube sedimentation tank to discharge a first-stage effluent; a dosage of the calcium fluoride being a range of 120-150 mg/L, and a dosage of the tremolite being in a range of 6-10% of the dosage of the calcium fluoride; and a shearing rate of the high-speed shearing machine being a range of 5,400-5,600 revolutions per minute (r/min);
step 3, introducing the first-stage effluent into a second-stage chemical sedimentation tank, adding calcium chloride and poly aluminum chloride into the second-stage chemical sedimentation tank sequentially in that order to obtain second-stage wastewater, stirring the second-stage wastewater to react to obtain reacted second-stage wastewater, introducing the reacted second-stage wastewater into a second-stage coagulation sedimentation tank, adding polyacrylamide into the second-stage coagulation sedimentation tank to obtain second-stage coagulating-sedimentation wastewater, and then flowing the second-stage coagulating-sedimentation wastewater into a second-stage inclined-tube sedimentation tank, and discharging a second-stage effluent through the second-stage inclined-tube sedimentation tank; and
step 4, performing a treatment on the second-stage effluent by using the TMF to obtain treated second-stage effluent, and then discharging the treated second-stage effluent.

In an embodiment, in the step 2, the calcium chloride is added according to a molar ratio of calcium to fluorine being a range of 2.0-2.3:1.

In an embodiment, in the step 2, a dosage of the poly aluminum chloride is in a range of 80-100 mg/L.

In an embodiment, in the step 2, a particle size of the tremolite is in a range of 600-700 meshes.

In an embodiment, in the step 2, a time of the shearing treatment is in a range of 20-30 min.

In an embodiment, in the step 3, the stirring the second-stage wastewater to react to obtain reacted second-stage wastewater:

stirring at a rotational speed of a range of 200-230 r/min to react for 5-10 min, and stirring at a rotational speed of a range of 50-100 r/min to react for 40-50 min.

In an embodiment, in the step 3, the calcium chloride is added according to a molar ratio of calcium to fluorine being 1.1:1.

In an embodiment, in the step 3, a dosage of the poly aluminum chloride is in a range of 45-55 mg/L, and a dosage of the polyacrylamide is in a range of 2-3 mg/L.

Compared with the related art, the disclosure has the following beneficial effects:

(1) The disclosure specially uses the amphibole var. tremolite with a specific particle size combined with the calcium fluoride as a seed crystal, and in combination with specific processes of shearing and stirring reaction, as well as the TMF, so that removal effect and removal efficiency of the fluorine ions are improved, achieving the removal rate of the fluorine ions of 99% or above, and greatly reducing moisture content of sludge.

(2) The disclosure specially uses the amphibole var. tremolite with the specific particle size combined with the calcium fluoride as the seed crystal to treat the fluorine-containing wastewater under the action of the specific process of shearing, thereby making the fluorine ions in the fluorine-containing wastewater quickly and stably deposit on the seed crystal, improving a growth rate of the seed crystal, and efficiently achieving the induced crystallization.

(3) The disclosure significantly reduces the dosages of calcium chloride, poly aluminum chloride, and polyacrylamide agents, reduces the production of sludge, reduces the moisture content of the sludge, increases a water yield, and facilitates secondary utilization of the wastewater.

### DETAILED DESCRIPTION OF EMBODIMENTS

In order to better understand the technical solutions of the disclosure, illustrated embodiments are provided below to further illustrate the disclosure.

If experimental methods used in the embodiments of the disclosure are not specifically described, the experimental methods are conventional methods.

Materials, reagents, etc. used in the embodiments of the disclosure are commercially available, unless otherwise specially described.

An initial concentration of fluorine ions in to-be-treated wastewater (also referred as to fluorine-containing wastewater) of the disclosure is in a range of 20-30 milligrams per liter (mg/L).

### Embodiment 1

A method for treating alkaline fluorine-containing wastewater by combining an induced crystallization method with a TMF includes the following steps.

Step 1, fluorine-containing wastewater is introduced into a regulating pond, and a potential of hydrogen (pH) of the fluorine-containing wastewater is regulated to 8.2 to obtain the alkaline fluorine-containing wastewater.

Step 2, the alkaline fluorine-containing wastewater is introduced from the regulating pond into a first-stage chemical sedimentation tank, and calcium chloride, poly aluminum chloride, calcium fluoride, and tremolite (also referred to as Amphibole var. tremolite) are added into the first-stage chemical sedimentation tank sequentially in that order to obtain first-stage fluorine-containing wastewater. Specifically, the calcium chloride is added according to a molar ratio of calcium to fluorine being 2.1:1, a dosage of the poly aluminum chloride is 90 milligrams per liter (mg/L), a dosage of the calcium fluoride is 130 mg/L, a particle size of the tremolite is 600 meshes, and a dosage of the tremolite is 8% of the dosage of the calcium fluoride. And then, shearing treatment is performed on the first-stage fluorine-containing wastewater by using a high-speed shearing machine at a shearing rate of 5,500 revolutions per minute (r/min) for 25 min to obtain sheared first-stage fluorine-containing wastewater. Thereafter, the sheared first-stage fluorine-containing wastewater is introduced into a first-stage coagulation sedimentation tank to obtain first-stage coagulating-sedimentation wastewater, and then the first-stage coagulating-sedimentation wastewater is introduced into a first-stage inclined-tube sedimentation tank to discharge a first-stage effluent.

Step 3, the first-stage effluent is introduced into a second-stage chemical sedimentation tank, and calcium chloride and poly aluminum chloride are added into the second-stage chemical sedimentation tank sequentially in that order to obtain second-stage wastewater. Specifically, the calcium chloride is added according to a molar ratio of calcium to fluorine being 1.1:1 and a dosage of the poly aluminum chloride is 50 mg/L. The second-stage wastewater is stirred at a rotational speed of 215 r/min to react for 8 min and then stirred at a rotational speed of 80 r/min to react for 45 min to obtain reacted second-stage wastewater. The reacted second-stage wastewater is introduced into a second-stage coagulation sedimentation tank, added with polyacrylamide with a dosage of 2.5 mg/L to obtain second-stage coagulating-sedimentation wastewater. Then, the second-stage coagulating-sedimentation wastewater is flowed into a second-stage inclined-tube sedimentation tank, and a second-stage effluent is discharged through the second-stage inclined-tube sedimentation tank.

Step 4, the second-stage effluent is treated by using the TMF to obtain treated second-stage effluent, and then the treated second-stage effluent is discharged.

### Embodiment 2

A method for treating alkaline fluorine-containing wastewater by combining an induced crystallization method with a TMF includes the following steps.

Step 1, fluorine-containing wastewater is introduced into a regulating pond, and a pH of the fluorine-containing wastewater is regulated to 8.0 to obtain the alkaline fluorine-containing wastewater.

Step 2, the alkaline fluorine-containing wastewater is introduced from the regulating pond into a first-stage chemical sedimentation tank, and calcium chloride, poly aluminum chloride, calcium fluoride, and tremolite are added into the first-stage chemical sedimentation tank sequentially in that order to obtain first-stage fluorine-containing wastewater. Specifically, the calcium chloride is added according to a molar ratio of calcium to fluorine being 2.0:1, a dosage of the poly aluminum chloride is 80 mg/L, a dosage of the calcium fluoride is 150 mg/L, a particle size of the tremolite is 600 meshes, and a dosage of the tremolite is 6% of the dosage of the calcium fluoride. And then, shearing treatment is performed on the first-stage fluorine-containing wastewater by using a high-speed shearing machine at a shearing rate of 5400 r/min for 30 min to obtain sheared first-stage fluorine-containing wastewater. Thereafter, the sheared first-stage fluorine-containing wastewater is introduced into a first-stage coagulation sedimentation tank to obtain first-stage coagulating-sedimentation wastewater, and then the first-stage coagulating-sedimentation wastewater is introduced into a first-stage inclined-tube sedimentation tank to discharge a first-stage effluent.

Step 3, the first-stage effluent is introduced into a second-stage chemical sedimentation tank, and calcium chloride and poly aluminum chloride are added into the second-stage chemical sedimentation tank sequentially in that order to obtain second-stage wastewater. Specifically, the calcium chloride is added according to a molar ratio of calcium to fluorine being 1.1:1 and a dosage of the poly aluminum chloride is 45 mg/L. The second-stage wastewater is stirred at a rotational speed of 200 r/min to react for 10 min and then stirred at a rotational speed of 100 r/min to react for 40 min to obtain reacted second-stage wastewater. The reacted second-stage wastewater is introduced into a second-stage coagulation sedimentation tank, added with polyacrylamide with a dosage of 3 mg/L to obtain second-stage coagulating-sedimentation wastewater. Then, the second-stage coagulating-sedimentation wastewater is flowed into a second-stage inclined-tube sedimentation tank, and a second-stage effluent is discharged through the second-stage inclined-tube sedimentation tank.

Step 4, the second-stage effluent is treated by using the TMF to obtain treated second-stage effluent, and then the treated second-stage effluent is discharged.

### Embodiment 3

A method for treating alkaline fluorine-containing wastewater by combining an induced crystallization method with a TMF includes the following steps.

Step 1, fluorine-containing wastewater is introduced into a regulating pond, and a pH of the fluorine-containing wastewater is regulated to 8.5 to obtain the alkaline fluorine-containing wastewater.

Step 2, the alkaline fluorine-containing wastewater is introduced from the regulating pond into a first-stage chemical sedimentation tank, and calcium chloride, poly aluminum chloride, calcium fluoride, and tremolite are added into the first-stage chemical sedimentation tank sequentially in that order to obtain first-stage fluorine-containing wastewater. Specifically, the calcium chloride is added according to a molar ratio of calcium to fluorine being 2.3:1, a dosage of the poly aluminum chloride is 100 mg/L, a dosage of the calcium fluoride is 120 mg/L, a particle size of the tremolite is 600 meshes, and a dosage of the tremolite is 10% of the dosage of the calcium fluoride. And then, shearing treatment is performed on the first-stage fluorine-containing wastewater by using a high-speed shearing machine at a shearing rate of 5600 r/min for 20 min to obtain sheared first-stage fluorine-containing wastewater. Thereafter, the sheared first-stage fluorine-containing wastewater is introduced into a first-stage coagulation sedimentation tank to obtain first-stage coagulating-sedimentation wastewater, and then the first-stage coagulating-sedimentation wastewater is introduced into a first-stage inclined-tube sedimentation tank to discharge a first-stage effluent.

Step 3, the first-stage effluent is introduced into a second-stage chemical sedimentation tank, and calcium chloride and poly aluminum chloride are added into the second-stage chemical sedimentation tank sequentially in that order to obtain second-stage wastewater. Specifically, the calcium chloride is added according to a molar ratio of calcium to fluorine being 1.1:1 and a dosage of the poly aluminum chloride is 55 mg/L. The second-stage wastewater is stirred at a rotational speed of 230 r/min to react for 5 min and then stirred at a rotational speed of 50 r/min to react for 50 min to obtain reacted second-stage wastewater. The reacted second-stage wastewater is introduced into a second-stage coagulation sedimentation tank, added with polyacrylamide with a dosage of 2 mg/L to obtain second-stage coagulating-sedimentation wastewater. Then, the second-stage coagulating-sedimentation wastewater is flowed into a second-stage inclined-tube sedimentation tank, and a second-stage effluent is discharged through the second-stage inclined-tube sedimentation tank.

Step 4, the second-stage effluent is treated by using the TMF to obtain treated second-stage effluent, and then the treated second-stage effluent is discharged.

Concentrations of fluorine ions in the fluorine-containing wastewater before and after treatment in the embodiments 1-3 are detected to calculate a removal rate of the fluorine ions, respectively, and meanwhile, moisture contents of sludge are detected and collected. Specially, the concentrations of fluorine ions in the fluorine-containing wastewater are determined by using fluorine reagents spectrophotometry, which are illustrated in the following Table 1:

TABLE 1
Results of treating fluorine-containing
wastewater in the embodiments 1-3

| | Fluorine ion | Fluorine | Removal | |
|---|---|---|---|---|
| | concentration of | content in | rate of | Moisture |
| | wastewater before | effluent | fluorine | content of |
| | treatment (mg/L) | (mg/L) | ion (%) | sludge (%) |
| Embodiment 1 | 23.18 | 0.14 | 99.40 | 15.7 |
| Embodiment 2 | 22.46 | 0.16 | 99.29 | 15.2 |
| Embodiment 3 | 23.63 | 0.18 | 99.24 | 15.1 |

The above results illustrate that the removal rates of the wastewater after being treated by the methods described in the embodiments 1-3 of the disclosure are above 99%, and the moisture contents of sludge are greatly reduced.

### Comparative Example 1

Compared with the embodiment 1, differences are that the tremolite is replaced with dolomite and the calcium fluoride is replaced with calcium fluorophosphate. Other processes are consistent with those in the embodiment 1. Specifically, fluorine-containing wastewater is introduced into a regulating pond, and a pH of the fluorine-containing wastewater is regulated to 8.2 to obtain the alkaline fluorine-containing wastewater; and the alkaline fluorine-containing wastewater is introduced from the regulating pond into a first-stage chemical sedimentation tank, and calcium chloride, poly aluminum chloride, calcium fluorophosphate, and dolomite are added into the first-stage chemical sedimentation tank sequentially in that order to obtain first-stage fluorine-containing wastewater. Specifically, the calcium chloride is added according to a molar ratio of calcium to fluorine being 2.1:1, a dosage of the poly aluminum chloride is 90 mg/L, a dosage of the calcium fluorophosphate is 130 mg/L, a particle size of the dolomite is 600 meshes, and a dosage of the dolomite is 8% of the dosage of the calcium fluorophosphate. And then, shearing treatment is performed on the first-stage fluorine-containing wastewater by using a high-speed shearing machine at a shearing rate of 5500 r/min for 25 min to obtain sheared first-stage fluorine-containing wastewater. Thereafter, the sheared first-stage fluorine-containing wastewater is introduced into a first-stage coagulation sedimentation tank to obtain first-stage coagulating-sedimentation wastewater, and then the first-stage coagulating-sedimentation wastewater is introduced into a first-stage inclined-tube sedimentation tank to discharge a first-stage effluent. Other processes are consistent with the embodiment 1.

### Comparative Example 2

Compared with the embodiment 1, a difference is that a dosage of the tremolite is 4% of the dosage of the calcium fluoride. Other processes are consistent with those in the embodiment 1. Specifically, fluorine-containing wastewater is introduced into a regulating pond, and a pH of the fluorine-containing wastewater is regulated to 8.2 to obtain the alkaline fluorine-containing wastewater; and the alkaline fluorine-containing wastewater is introduced from the regulating pond into a first-stage chemical sedimentation tank, and calcium chloride, poly aluminum chloride, calcium fluoride, and tremolite are added into the first-stage chemical sedimentation tank sequentially in that order to obtain first-stage fluorine-containing wastewater. Specifically, the calcium chloride is added according to a molar ratio of calcium to fluorine being 2.1:1, a dosage of the poly aluminum chloride is 90 mg/L, a dosage of the calcium fluoride is 130 mg/L, a particle size of the tremolite is 600 meshes, and a dosage of the tremolite is 4% of the dosage of the calcium fluoride. And then, shearing treatment is performed on the first-stage fluorine-containing wastewater by using a high-speed shearing machine with a shearing rate of 5500 r/min for 25 min to obtain sheared first-stage fluorine-containing wastewater. Thereafter, the sheared first-stage fluorine-containing wastewater is introduced into a first-stage coagulation sedimentation tank to obtain first-stage coagulating-sedimentation wastewater, and then the first-stage coagulating-sedimentation wastewater is introduced into a first-stage inclined-tube sedimentation tank to discharge a first-stage effluent. Other processes are consistent with the embodiment 1.

### Comparative Example 3

Compared with the embodiment 1, differences are that a shearing rate is at 2000 r/min and a time for the shearing treatment is 15 min. Other processes are consistent with those in the embodiment 1. Specifically, fluorine-containing wastewater is introduced into a regulating pond, and the pH of the fluorine-containing wastewater is regulated to 8.2 to obtain the alkaline fluorine-containing wastewater; and the alkaline fluorine-containing wastewater is introduced from the regulating pond into a first-stage chemical sedimentation tank, and calcium chloride, poly aluminum chloride, calcium fluoride, and tremolite are added into the first-stage chemical sedimentation tank sequentially in that order to obtain first-stage fluorine-containing wastewater. Specifically, the calcium chloride is added according to a molar ratio of calcium to fluorine being 2.1:1, a dosage of the poly aluminum chloride is 90 mg/L, a dosage of the calcium fluoride is 130 mg/L, a particle size of the tremolite is 600 meshes, and a dosage of the tremolite is 8% of the dosage of the calcium fluoride. And then, shearing treatment is performed on the first-stage fluorine-containing wastewater by using a high-speed shearing machine with a shearing rate of 2000 r/min for 15 min to obtain sheared first-stage fluorine-containing wastewater. Thereafter, the sheared first-stage fluorine-containing wastewater is introduced into a first-stage coagulation sedimentation tank to obtain first-stage coagulating-sedimentation wastewater, and then the first-stage coagulating-sedimentation wastewater is introduced into a first-stage inclined-tube sedimentation tank to discharge a first-stage effluent. Other processes are consistent with the embodiment 1.

Concentrations of fluorine ions in the fluorine-containing wastewater before and after treatment in the comparative examples 1-3 are detected to calculate a removal rate of the fluorine ions, respectively, and meanwhile, moisture contents of sludge are detected and collected. Specially, the concentrations of fluorine ions in the fluorine-containing wastewater are determined by using fluorine reagents spectrophotometry, which are illustrated in the following Table 2:

TABLE 2
Results of treating fluorine-containing wastewater
in the comparative examples 1-3

| | Fluorine ion | Fluorine | Removal | |
|---|---|---|---|---|
| | concentration of | content in | rate of | Moisture |
| | wastewater before | effluent | fluorine | content of |
| | treatment (mg/L) | (mg/L) | ion (%) | sludge (%) |
| Comparative | 22.38 | 1.82 | 91.87 | 16.2 |
| example 1 | | | | |
| Comparative | 22.91 | 1.22 | 94.67 | 20.7 |
| example 2 | | | | |
| Comparative | 22.07 | 0.70 | 96.83 | 18.3 |
| example 3 | | | | |

In the comparative example 1, the dolomite is used to replace the tremolite, and the calcium fluorophosphate is used to replace the calcium fluoride, thereby reflecting that the removal effect of fluorine ions is significantly reduced compared with the embodiment 1. Therefore, the disclosure combines the tremolite with the calcium fluoride, which can achieve better defluorination effect. The disclosure uses a synergistic effect of the tremolite and the calcium fluoride as the seed crystal, promoting the rapid and stable deposition of fluorine ions in the wastewater on the seed crystal, improving the growth rate of the seed crystal, and improving the defluorination effect.

Compared with the embodiment 1, the comparative example 2 reduces the dosage of the tremolite, thereby reducing the treatment effect of the fluorine-containing wastewater 1. The disclosure uses the specific dosage of the tremolite to improve the treatment effect of the fluorine-containing wastewater.

Compared with the embodiment 1, the comparative example 3 adjusts the shearing treatment thereof, which reduces the removal rate of fluoride ions, and increases the moisture content of sludge. The shearing treatment according to the disclosure can achieve the better defluorination effect, and facilitates reducing the moisture content of sludge.

The above are only the illustrated embodiments of the disclosure and are not intended to limit the disclosure, and any modifications, equivalent replacements, improvements, etc. made within the spirit and principle of the disclosure should be included within the scope of the protection of the disclosure.

What is claimed is:

1. A method for treating alkaline fluorine-containing wastewater by combining an induced crystallization method with a tubular membrane filter (TMF), comprising:
step 1, introducing fluorine-containing wastewater into a regulating pond, and regulating a potential of hydrogen (pH) of the fluorine-containing wastewater to a range of 8.0-8.5 to obtain the alkaline fluorine-containing wastewater;
step 2, introducing the alkaline fluorine-containing wastewater from the regulating pond into a first-stage chemical sedimentation tank, adding calcium chloride, poly aluminum chloride, calcium fluoride, and tremolite into the first-stage chemical sedimentation tank sequentially in that order to obtain first-stage fluorine-containing wastewater, performing shearing treatment on the first-stage fluorine-containing wastewater by using a high-speed shearing machine to obtain sheared first-stage fluorine-containing wastewater, introducing the sheared first-stage fluorine-containing wastewater into a first-stage coagulation sedimentation tank to obtain first-stage coagulating-sedimentation wastewater, and then introducing the first-stage coagulating-sedimentation wastewater into a first-stage inclined-tube sedimentation tank to discharge a first-stage effluent;
wherein a dosage of the calcium fluoride is in a range of 120-150 milligrams per liter (mg/L), and a dosage of the tremolite is in a range of 6-10% of the dosage of the calcium fluoride; and a shearing rate of the high-speed shearing machine is in a range of 5,400-5,600 revolutions per minute (r/min);
step 3, introducing the first-stage effluent into a second-stage chemical sedimentation tank, adding calcium chloride and poly aluminum chloride into the second-stage chemical sedimentation tank sequentially in that order to obtain second-stage wastewater, stirring the second-stage wastewater to react to obtain reacted second-stage wastewater, introducing the reacted second-stage wastewater into a second-stage coagulation sedimentation tank, adding polyacrylamide into the second-stage coagulation sedimentation tank to obtain second-stage coagulating-sedimentation wastewater, and then flowing the second-stage coagulating-sedimentation wastewater into a second-stage inclined-tube sedimentation tank, and discharging a second-stage effluent through the second-stage inclined-tube sedimentation tank; and
step 4, performing a treatment on the second-stage effluent by using the TMF to obtain treated second-stage effluent, and then discharging the treated second-stage effluent.

2. The method as claimed in claim 1, wherein in the step 2, the calcium chloride is added according to a molar ratio of calcium to fluorine being a range of 2.0-2.3:1.

3. The method as claimed in claim 1, wherein in the step 2, a dosage of the poly aluminum chloride is in a range of 80-100 mg/L.

4. The method as claimed in claim 1, wherein in the step 2, a particle size of the tremolite is in a range of 600-700 meshes.

5. The method as claimed in claim 1, wherein in the step 2, a time of the shearing treatment is in a range of 20-30 min.

6. The method as claimed in claim 1, wherein in the step 3, the stirring the second-stage wastewater to react to obtain reacted second-stage wastewater comprises:
stirring at a rotational speed of a range of 200-230 r/min to react for 5-10 min, and stirring at a rotational speed of a range of 50-100 r/min to react for 40-50 min.

7. The method as claimed in claim 1, wherein in the step 3, the calcium chloride is added according to a molar ratio of calcium to fluorine being 1.1:1.

8. The method as claimed in claim 1, wherein in the step 3, a dosage of the poly aluminum chloride is in a range of 45-55 mg/L, and a dosage of the polyacrylamide is in a range of 2-3 mg/L.

9. The method as claimed in claim 1, wherein in the step 1, a concentration of fluorine ions before treating the fluorine-containing wastewater is in a range of 20-30 mg/L.
